(19) United States
(12) Patent Application Publication
(10) Pub. No.: US 2014/0165003 A1
(43) Pub. Date: Jun. 12, 2014

(54) TOUCH SCREEN DISPLAY

(71) Applicant: APPSENSE LIMITED, Warrington (GB)

(72) Inventors: Paul Keith BRANTON, Rochdale (GB); Andrew LEA, Cheshire (GB); Richard James SOMERFIELD, Cheshire (GB)

(73) Assignee: APPSENSE LIMITED, Warrington (GB)

(21) Appl. No.: 13/712,356

(22) Filed: Dec. 12, 2012

(51) Int. Cl. G06F 3/0481

(52) U.S. Cl. CPC G06F 3/04817
USPC 715/835

(57) ABSTRACT

Systems and methods are disclosed for a slide-in menu that provides extended actions for grid layouts on touch screen devices. The slide-in menu provides a signposted visual interface object for user interaction with an application that is discoverable and usable and that provides several selectable options for touch-screen users, while requiring minimal screen real estate and retaining touch target sizes for individual screen controls that is appropriate for touch screen users. The slide-in menu may be augmented with an additional plurality of menu options and with a “more” button that displays the additional plurality of menu options.

### BACKGROUND

Various techniques and conventions have been developed over time for providing interfaces to touch screen devices. Touch screens are generally devices that combine a display screen with touch sensors, and are typically operated by touching objects shown on the display screen with one or more fingers, styluses, or other means. These devices can turn the physical impulses into electrical impulses using capacitive or resistive sensors, which are in turn delivered to a computer or other processing device connected to the touch sensors and to the display screen. Because both the human visual system and the human kinesthetic system are used for the interaction, the effect of some touch screens approximates the sensation of touching and interacting with physical devices in the physical world.

Touch screen interfaces have developed for users on devices that share certain characteristics, which include the limitation of limited screen area (e.g., many touch screen devices are portable ones that are sized for being carried around by the user); the limitation of the size of the tool used for interaction, the human finger or a stylus, each of which typically require controls to be no smaller than a certain minimum size; and the limitation of legibility or comprehensibility that results as a corollary when space for labels is scarce. While there are certain touch screen interface “widgets” and controls that are conventional and widely used, there remains a need for innovative touch screen controls that can help overcome one or more of these limitations.

### SUMMARY

In accordance with the disclosed subject matter, systems, methods, and non-transitory computer-readable media can provide a user interface on a touch screen display.

In one embodiment, a computerized method for use with a touch screen is provided, the method comprising: displaying, at a first location in proximity to a first side of the touch screen, a composite icon representing a data object and functionality associated with the data object; detecting a touch on the touch screen in proximity to the composite icon; translating the composite icon from the first location to a second location in proximity to a second side of the touch screen; translating a plurality of action icons onto the touch screen; and monitoring the touch screen for additional touches in proximity to at least one of the composite icon and the plurality of action icons, wherein detecting the touch in proximity to the composite icon causes the action icons to be displayed if the action icons are not displayed before the touch is detected, and wherein detecting the touch in proximity to the composite icon causes the action icons to be hidden if the action icons are displayed before the touch is detected.

The composite icon further includes an object icon and a signpost icon. The signpost icon further includes a first state when the action icons are displayed and a second state when the action icons are not displayed. The plurality of action icons further includes a command icon for causing a plurality of additional action icons to be displayed. The method further comprises: detecting a second touch on the touch screen in proximity to the command icon; translating one or more of the plurality of action icons off of the touch screen; and translating the plurality of additional icons onto the touch screen from the first side of the touch screen. The first side is a left edge of the touch screen and the second side is a right edge of the touch screen. The signpost icon is graphically labeled to indicate respective functionality, and is smaller than the object icon.

In another embodiment, a computing device is provided, comprising: a touch screen; one or more processors; a non-transitory memory storing computer-readable instructions that, when executed by the one or more processors, cause the one or more processors to: display, at a first location in proximity to a first side of the touch screen, a composite icon representing a data object and functionality associated with the data object; detect a touch on the touch screen in proximity to the composite icon; translate the composite icon from the first location to a second location in proximity to a second side of the touch screen; translate a plurality of action icons onto the touch screen; and monitor the touch screen for additional touches in proximity to at least one of the composite icon and the plurality of action icons, wherein detecting the touch in proximity to the composite icon causes the action icons to be displayed if the action icons are not displayed before the touch is detected, and wherein detecting the touch in proximity to the composite icon causes the action icons to be hidden if the action icons are displayed before the touch is detected.

The composite icon further includes an object icon and a signpost icon. The signpost icon further includes a first state when the action icons are displayed and a second state when the action icons are not displayed. The plurality of action icons further includes a command icon for causing a plurality of additional action icons to be displayed. The computer-readable instructions can further cause the one or more processors to: detect a second touch on the touch screen in proximity to the command icon; translate one or more of the plurality of action icons off the touch screen; and translate the plurality of additional icons onto the touch screen from the first side of the touch screen. The first side is a left edge of the touch screen and the second side is a right edge of the touch screen. The signpost icon is graphically labeled to indicate respective functionality, and is smaller than the object icon.

In another embodiment, a non-transitory computer-readable medium is provided, the medium having executable instructions operable to, when executed by a computing device, cause a computing device to: display, at a first location in proximity to a first side of the touch screen, a composite icon representing a data object and functionality associated with the data object; detect a touch on the touch screen in proximity to the composite icon; translate the composite icon from the first location to a second location in proximity to a second side of the touch screen; translate a plurality of action icons onto the touch screen; and monitor the touch screen for additional touches in proximity to at least one of the composite icon and the plurality of action icons, wherein detecting the touch in proximity to the composite icon causes the action icons to be displayed if the action icons are not displayed before the touch is detected, and wherein detecting the touch in proximity to the composite icon causes the action icons to be hidden if the action icons are displayed before the touch is detected.

The composite icon further includes an object icon and a signpost icon. The signpost icon further includes a first state while the action icons are displayed and a second state while the action icons are not displayed. The plurality of action icons further includes a command icon for causing a plurality of additional action icons to be displayed. The executable instructions can be further operable to cause the computing device to: detect a second touch on the touch screen in proximity to the command icon; hide one or more of the plurality of action icons; and display the plurality of additional action icons. The first state of the signpost icon and the second state of the signpost icon are graphically labeled to indicate respective functions and are each smaller than the object icon, and wherein the first side is a left edge of the touch screen and the second side is a right edge of the touch screen.

### BRIEF DESCRIPTION OF DRAWINGS

FIG. 1 is an exemplary wireframe diagram of a touch screen menu interface.

FIG. 2 is an exemplary wireframe diagram of a touch screen menu interface in a closed state.

FIG. 3 is an exemplary wireframe diagram of a touch screen menu interface in an open state.

FIG. 4 is an exemplary wireframe diagram of a touch screen menu interface in an open state indicating the presence of additional menu options.

FIG. 5 is an exemplary system diagram of a mobile touch screen device capable of providing the described touch screen menu interface.

### DETAILED DESCRIPTION

In the following description, specific details are set forth regarding the systems and methods of the disclosed subject matter and the environment in which such systems and methods can operate in order to provide a thorough understanding of the disclosed subject matter. It will be apparent to one skilled in the art, however, that the disclosed subject matter can be practiced without such specific details, and that certain features well-known in the art are not described in detail in order to avoid unnecessary complication of the disclosed subject matter. In addition, it will be understood that the embodiments provided herein are exemplary, and that techniques are contemplated and within the scope of the disclosed subject matter.

Embodiments are described herein of a slide-in menu that can provide extended actions for grid layouts on touch screen devices. The slide-in menu can provide a signposted visual interface object for user interaction with an application that is discoverable and usable and that provides several selectable options for touch-screen users, while requiring minimal screen real estate and retaining touch target sizes for individual screen controls that is appropriate for touch screen users. Other embodiments are within the scope of the subject matter disclosed herein.

Mobile user interfaces for touch screens can be developed with the awareness that such user interfaces have limitations inherent to the touch screen medium. For example, these limitations can include available screen area, since if a button is too large, it will obscure relevant data; the size of the finger, which is the most common means for interaction but cannot reliably make contact with screen elements or touch targets that are smaller than a certain size; and the limited ability to provide “tool tips” or other in-line help information, aside from short text labels placed adjacent to a button. These limitations can make providing supplementary commands difficult. A user interface element can be called a widget.

In some cases, user interface designs can rely on touch screen-specific conventions. These conventions can allow certain controls to be presented while requiring little or no visual screen area, and allowing the use of large touch targets. Examples of such conventions include: scrollable screen areas that do not display scroll bars; pinch-to-zoom interactions that rely on multi-touch operation to provide rotation and/or scaling of a visual element using direct manipulation of the visual element in the plane of the display; and swiping interactions to move discrete items on the screen to other locations on or off the screen, or to show or hide additional controls, such as a Delete control accessed by swiping to the right on a file or a row of a table. However, since these controls are effectively invisible, many users can be unaware of their existence, or can be unaware of how to operate the controls.

Another factor weighing against hidden controls is that the number of controls that can be implemented using invisible or hidden gestures can be limited by the user's inability to remember or reproduce distinct gestural input patterns without visual feedback. This approach thus does not scale well to the number of distinct commands that can be required by an application.

Applications that deal with files, or other discrete data objects, often do require a user interface that supports a large number of direct commands. This is because users are accustomed to the diversity of commands that are traditionally made available on windows, icons, menu and pointer (WIMP)-based systems. On such legacy systems, the list of commands that applies to a particular file can easily be displayed by performing a mouse secondary click or “right-click” on the file. This can bring up a contextual menu that provides all actions that are available to the user that make sense at that time the user right-clicks the file. No direct analog to a “right-click” has been widely used or made available on new touch screen interfaces. Providing commands that have been traditionally presented using contextual menus has thus been a challenge.

To address some of these challenges, a new user interface element/widget is provided herein for providing commands that are contextually applicable to files and other discrete data objects. Signposting is provided for enhanced discoverability of functions by users. In-place animations and layout of functions near the related data object result in economical use of screen real estate. The number and type of functions are not artificially limited by the space available. Particular embodiments that provide appropriate functionality for the mobile device form factor are also described.

In some embodiments, a user interface means or user interface control, which can be called a widget, can be used in conjunction with a list view, a table view, a grid view, a tile view, or other user interface screen or view that presents multiple screen areas, each associated with a data object, such as a file. This widget enables a user to perform functions that apply to the data object or file, by displaying one or more action buttons in proximity to, and in association with, an icon representing the data object, in some embodiments. Displaying the action buttons in proximity is additionally enabled without excessive use of screen real estate by hiding the action buttons when not needed, and providing controls for showing and hiding the action buttons and bringing the widget to an open and a closed state. The action buttons can include icons, graphics, small photos, text labels, a button-shaped bevel or shape, some combination of the above, or anything else appropriately sized for interaction with a finger or other touch screen control device.

By displaying the action buttons in proximity to a data object, but only when needed, the described widget can provide the advantage of not requiring excessive screen real estate, in some embodiments, while promoting discoverability and recall for a user by allowing the user to group the functions to be performed with the file the functions will be performed on. Because typically the only time that the buttons are available is when they relate to a particular file, the association of actions and files can also allow a user to quickly select both an operation (the action) and an operand (the file) without cluttering the screen with visually-indistinguishable buttons.

Additionally, in a typical table user interface view, some user interfaces use a convention where sliding from left to right symbolizes accessing data at a greater level of detail, e.g., drilling down to a deeper level of a tree data structure, a nested data structure, or a table with multiple columns or nested table. In some embodiments, the operation of the widget can incorporate the conventional element of sliding from left to right, thereby providing visual and semantic cohesion within the larger user interface context.

In some embodiments, the menu can comfortably accommodate four buttons at a size conducive to touch selection when a mobile device is held in one hand in a portrait orientation. Different numbers of buttons can be contemplated when a mobile device is held in a different orientation such as landscape, or when this widget is used on a tablet device or other touch screen device, or at other times. In some embodiments, the number of buttons can be dynamic based on one or more of these factors, and the change in number of buttons can be animated. If further menu items are required, the fourth position, or the last position, in a menu row can be used to display a “more” action button, which reveals a further set of menu actions. This paradigm can be repeated to house as many menu items as necessary, in some embodiments. However, restricting the number of actions displayed at any given time improves usability for the touch screen user, who is able to select a correct action with minimal tapping while experiencing minimal cognitive load.

Generally, signposting is a concept wherein the availability of hidden information or functionality is made known to the user. Signposting can be done in a visual manner by using a part of the on-screen user interface to display a symbol, marker, or other visible cue to the user. While the user may not immediately understand the significance of the symbol, marker, or visible cue at first glance, the signpost is discoverable because it is not hidden. The signpost also allows the user to interact with it, and can thus provide increased user engagement as a benefit as well. Once the user interacts with a signpost, the user should be able to determine how to access the hidden information. The present disclosure uses signposting to indicate the availability of hidden context-sensitive buttons.

In some embodiments, signposting can be used to indicate the existence of the action buttons when the user interface widget is in a closed state and the action buttons are hidden offscreen. A visible icon, button or other visual representation on a touch screen can serve this purpose. This can be known as a signpost. In some embodiments, this signpost can be used to cause the hidden buttons to become non-hidden. Clicking on or touching the signpost can cause hidden buttons to slide in from off-screen. Sliding can also be used, as can double-tapping or otherwise interacting with the signpost. The hidden buttons can slide from left to right, from off the left side of the case to the right side of the case. When the hidden buttons are displayed, this state can be called an open state, because conceptually the hidden buttons are “inside” of a container, and when the buttons are made available for action, the container can be considered open.

In some embodiments, signposting can also be used to indicate the existence of functionality to close the user interface widget when it is in an open state. When a widget is in an open state, one or more action buttons can be shown on screen in some embodiments. A visible icon, button or other visual representation on the touch screen can be shown as a signpost to show that the action button can be hidden. Closing the user interface widget can be accomplished by touching this second signpost.

In some embodiments, signposting can also be used to indicate the existence of hidden buttons when the user interface is in the open state. When a widget is in the open state, one or more action buttons on the screen can be replaced with a special button labeled to suggest that there are additional buttons. In some embodiments, the button can be labeled “More . . . ” When the user touches this button, the widget can cause additional action buttons to come into view.

The action buttons themselves can represent actions to be performed on the object or file associated with the action buttons, in some embodiments. The action buttons can provide actions such as downloading, locking/unlocking, encrypting, deleting, copying, emailing, sharing, caching, or uploading. The action buttons can also provide actions such as sending via one or more social networks such as Facebook or Twitter, copying the file to a system-wide clipboard, compressing/decompressing, adding to a set or compressed archive, or performing one or more editing functions. The action buttons can allow for an action to be performed using the object or file as one operand to the action, and can allow for separately, simultaneously, modally or implicitly selecting one or more additional operands, for actions that can accept two or more operands to perform the requested action. A user can select one of the action buttons using a touch interaction, in some embodiments.

In some embodiments, the widget can operate as follows. When a user examines a file list, the user can choose to display the menu for one of the files by tapping or touching a user interface control at a signposted location at the left side of a table row. The user interface control can be made small enough to be unobtrusive. The signposted location can be to the left of a file icon in the table row, and can be near the left edge of the touch screen, and can be located next to a graphical representation of a data object, such that the signposted location and user interface control suggest that options will be displayed that relate to the associated data object. With relation to the user's touch action, the touch target for causing the menu to slide into view can be sized appropriately for the user's finger. As in many instances action buttons and object buttons already exist, and as in those instances the buttons are already sized appropriately, the existing action button or object button can also be tapped or touched to activate the menu and to cause it to slide in from the left, in addition to the signposted location and/or the user interface control being tappable or touchable.

When the user touches the user interface control, action button or object button described above, a menu can slide into view from the left. This menu can apply to the file or data object in the table row. Tapping a menu item or action button can cause it to execute. The menu can contain any number of menu items. As described above, four menu items can be provided in the case of a widget optimized for a mobile device in portrait orientation. In some embodiments, the menu can slide in from the left. If the total number of menu items is greater than the number of places available, a “more” button can be provided, in which case the “more” button allows additional sets of menu action buttons can slide in from the left as well, displacing the currently-displayed set of menu action buttons, and additional actions enter from the left and exit from the right. When the user has finished interacting with the menu, the user can tap a small control at the end of the row in proximity to the file icon, similar to the initial signposted menu control but located on the other side of the file icon. Tapping this icon results in the action buttons sliding back out of view to the left, and returning the row to its original, closed state. In the case where a menu has many groups of actions accessible using a “more” button, a user can always return to the first group by closing the menu and then reopening it.

Touching, pressing or tapping the “more” button when no more action buttons are available can be handled in several different ways. In some embodiments, the “more” button can be grayed out or disabled when no further actions are available. In other embodiments, the “more” button can always be available, and pressing the button after all action buttons have been displayed can result in the final set of action buttons sliding offscreen to the right and being replaced with the first set of action buttons, imitating the action of a carousel whose items are arranged in a loop.

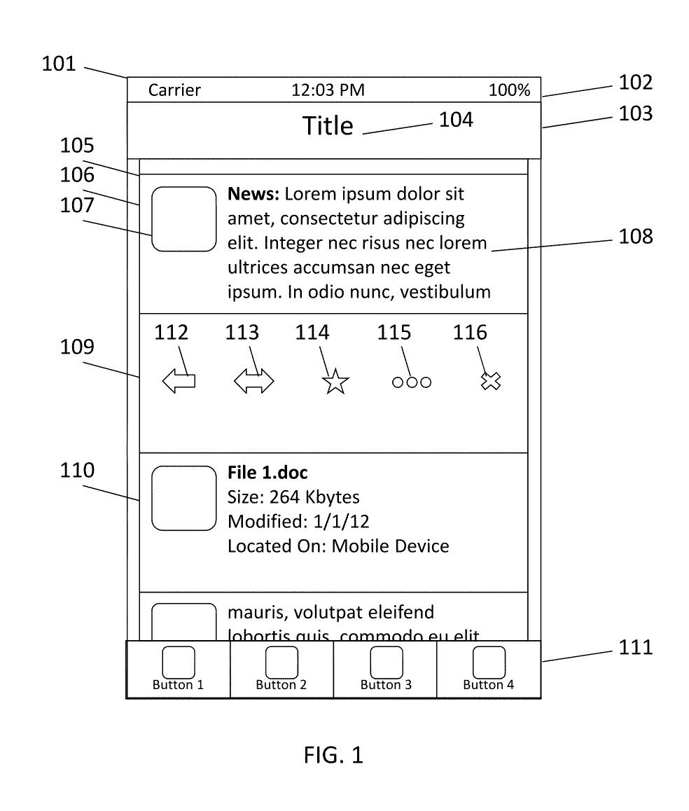

FIG. 1 is an exemplary wireframe diagram of a touch screen menu interface. View 101 typically represents the full viewable area on a mobile device, such as an Apple iOS iPhone® device, or a mobile device running the open source Android® operating system. Status bar 102 can display status information for the mobile device, such as a cell network provider logo and signal strength indicator, the current time, and the level of charge of a battery of the mobile device. Title bar 103 can include title 104, where title 104 describes and characterizes the content shown on the rest of the screen.

Table view 105 includes multiple rows 106, 109, 110, each associated with a single file or data object. Icon 107 represents an individual file, and text 108 represents information about the file, such that each element in row 106 represents information about the same single file. Row 106 is in a closed state. Row 109 is a table row associated with a single file or data object as well; however, row 109 shows only buttons 112, 113, 114, 115, 116. These buttons can be associated with the file displayed in row 109, and can be hidden. To display these buttons, a swipe gesture can be used while the row is in the closed state. Another swipe gesture can be used to hide these buttons. There is typically no visual indication that the rows are capable of being ‘opened’ or ‘closed’ to hide/show the buttons, leading to the disadvantage that this interaction is not discoverable and will remain unknown to most, if not all, users. At the bottom of the screen is a row of buttons 111 that can represent modes of an application.

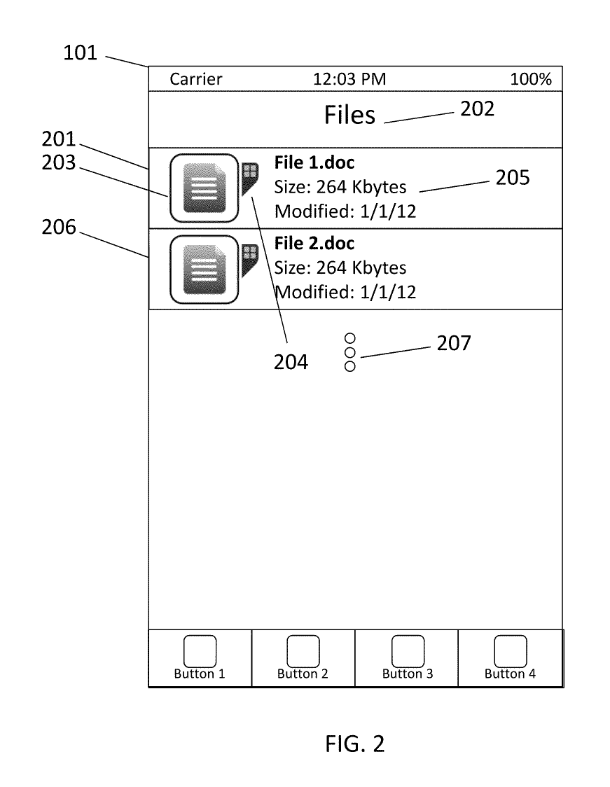

FIG. 2 is an exemplary wireframe diagram of a touch screen menu interface in a closed state. View 101 typically represents the full viewable area on the mobile device. Title 202 reflects that this view is a listing of files. Rows 201 and 206 are shown, each representing one file; additional rows are not shown but are represented by ellipsis 207.

File icon 203 is accompanied by handle 204, which is a discoverable, visible button located in proximity to file icon 203. Handle 204 is represented visually as a tab, similar to a folder tab or a tab on a physical package, suggesting to the user that handle 204 is a user interface control or widget. (The entire table row 201 can be considered a widget, and individual parts of the table row can also be considered to be widgets also.) On the handle is a miniaturized representation of a plurality of action buttons. Handle 204 is located to the right of icon 203, suggesting that a user can pull it to reveal further objects beneath it and to the left of what is currently displayed. Handle 204 is an example of a signposted location because, for example, it is visible, and gives an indication about its function. Row 201 also contains descriptive text 205. Row 206 is similarly configured to row 201. In some embodiments, handle 204 can be any graphical element designed to draw the eye of a user to the icon, thereby providing signposting.

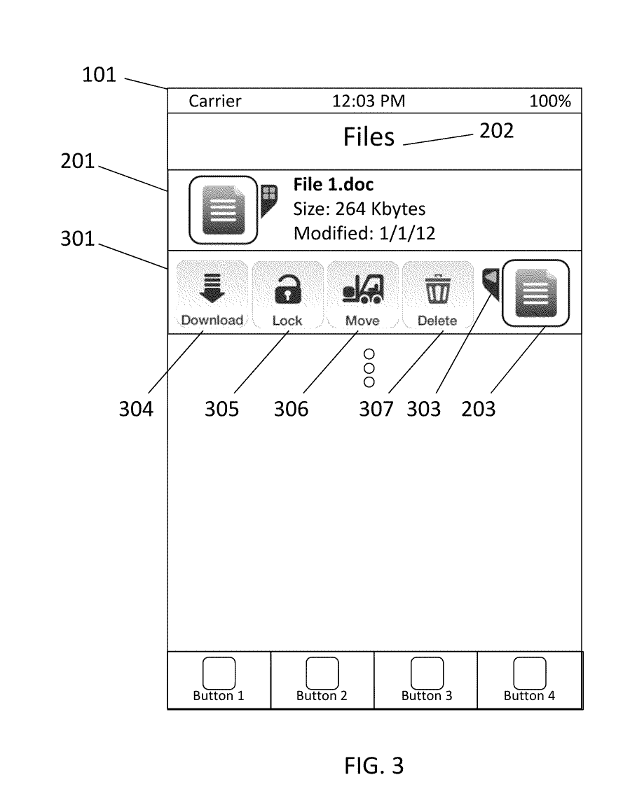

FIG. 3 is an exemplary wireframe diagram of a touch screen menu interface in an open state. View 101 typically represents the full viewable area on the mobile device. Row 201 is shown representing one file; this row is shown in the closed state described more fully with the description of FIG. 2. Row 301 is shown in the open state. This state can be triggered, for example, when a user touches, taps, or toggles handle 204 in FIG. 2. A slide or drag gesture can also be supported, in some embodiments. When the open state is triggered, file icon 203 can slide or translate across the screen from the left edge to the right edge. It can remain on the screen but in a different location. Handle 204 can disappear, fade out, or can otherwise be hidden. Handle 303 can appear, fade in, or otherwise be made visible. In addition, in some embodiments, title 202 can change to represent the item now shown or hidden by the slide-out menu. An exemplary title could be “File 2.doc.” Another exemplary title could be “File 2.doc Options.” Other titles or the original title can also be used.

In appearance, handle 303 can be similar to handle 204, but can be oriented in the opposite direction, located on the opposite side of file icon 203, and can be labeled with an icon that suggests movement of the table row to the left; the user may understand that the table row will slide back to the left when this handle is triggered. Action buttons 304, 305, 306, 307, which can each represent an action that can be performed on file 203, can slide in as a group from the left edge of the screen. The action buttons can be sized for easy manipulation by a finger. When the action buttons are visible, the row widget 301 is typically referred to as being in an open state. The closed state can be triggered by, for example, touching or tapping handle 303, or dragging it to the left in some embodiments.

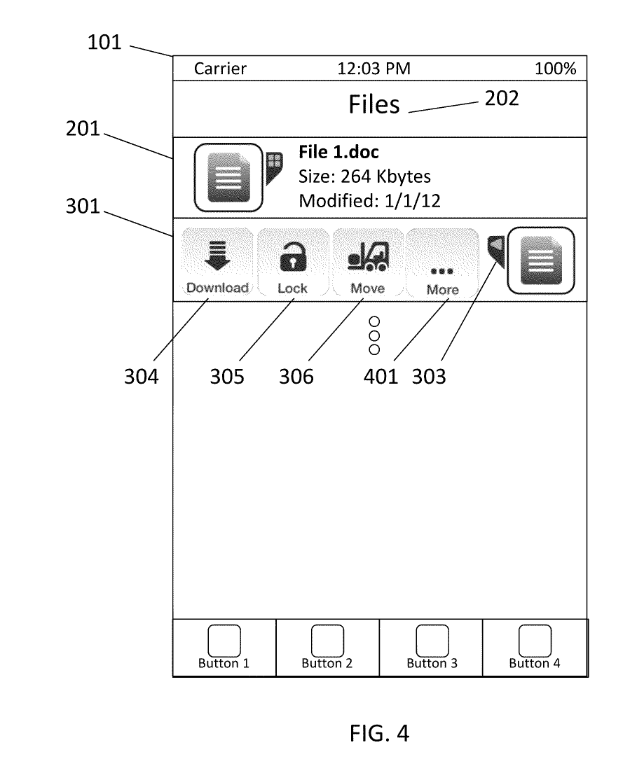

FIG. 4 is an exemplary wireframe diagram of a touch screen menu interface in an open state indicating the presence of additional menu options. Row 201 is shown representing one file; this row is shown in the closed state described more fully with the description of FIG. 2. Row 301 is shown in the open state. This state can be triggered, for example, once a user touches, taps, or toggles handle 204 in FIG. 2. Row 301 can contain action buttons, as described above with reference to FIG. 3, but includes action button 401 in the last action button slot. Action button 401 can be labeled “More,” and for its icon can have an ellipsis. This iconography and label can indicate to the user that additional action buttons are available. When this button is tapped or touched, additional action buttons can slide in to replace buttons 304, 305, and 306. In some embodiments, buttons 304, 305, 306, and 401 will slide out, and four new buttons will slide in. In other embodiments, buttons 304, 305, 306, and 401 will slide out, and three new buttons will slide in, with the fourth button location filled with another button that appears identical to button 401. Other animations can be contemplated and present in other embodiments of the subject matter disclosed herein. As described above, touching the More button when the last group of buttons is active can result in the first group of buttons returning to the screen. Alternatively, the user can toggle handle 303 to close the row, and then toggle handle 204 while the row is closed to return to viewing the first group of action buttons, in some embodiments.

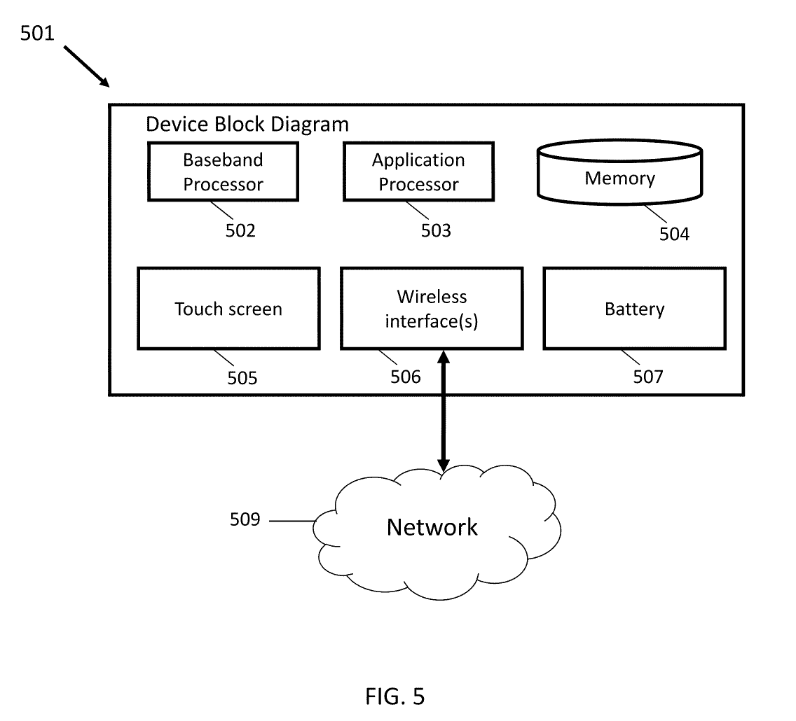

FIG. 5 is an exemplary system diagram of a mobile touch screen device capable of providing the described touch screen menu interface. Device block diagram 501 includes baseband processor 502, application processor 503, memory 504, touch screen 505, wireless interface(s) 506, and battery 507. Additional capabilities and functions can be present within the mobile touch screen device, including but not limited to: wired communications UART modules, serial communications modules, audio playback circuitry, audio compression and coding circuitry, digital signal processing modules, power amplifiers, and one or more antennas.

Wireless interface(s) 506 can include interfaces for one or more of the following wireless technologies: 802.11b, a, g, n; UMTS; CDMA; WCDMA; OFDM; LTE; WiMax; Bluetooth; or other wireless technology, and can use one or more antennas (not shown) or other means to communicate with network 508. Baseband processor 502 can be used to perform telecommunications functions, such as channel coding, and to interface with the wireless interface(s) 506.

Application processor 503 can run operating system software and application software, and can be a general-purpose microprocessor using an instruction set from Intel Corporation, AMD Corporation, or licensed from ARM Inc. The processor can include graphics capabilities for providing pixel data for display on touch screen 505, or graphics capabilities can be provided by a separate graphics coprocessor. Touch screen 505 can include touch detection circuitry, and can include display circuitry.

Memory 504 can store working instructions and data for one or both of application processor 503 and baseband processor 502, in addition to storing data, files, music, pictures, or other data to be used by the mobile device and/or its user, and can be a flash memory, a programmable read-only memory (PROM), a read-only memory (ROM), or any other memory or combination of memories. An operating system stored in memory 504 can include device management functionality for managing the touch screen and other components.

Battery 507 can be controlled by application processor 503 and can provide electrical power to the mobile device when not connected to a power source. Network 509 can be a cellular telephone network, a home or public WiFi network, the public Internet via one or more of the above, or another network.

The mobile touch screen device can be an Apple iPhone® or iPod® or iPad® or other iOS device, or a device using the Android® operating system, or a device using the Windows® operating system for mobile devices. The mobile touch screen device can include cellular telephony capabilities.

In addition to the embodiments described above, various alternatives are contemplated, including automatic or dynamic ordering of menu items; automatically resizing interface elements for tablet and landscape orientation interfaces; providing contextual menu items for non-table row implementations, where the handles are still placed in proximity to an icon representing a data object and used to provide access to the contextual menu for that data object; multiple nesting of contextual menus, in which some of the action buttons also have handles for opening and closing contextual menus on the action buttons themselves; and other alternatives.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers).

A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

What is claimed is:

1. A computerized method for use with a touch screen, the method comprising:
displaying, at a first location in proximity to a first side of the touch screen, a composite icon representing a data object and functionality associated with the data object;
detecting a touch on the touch screen in proximity to the composite icon;
translating the composite icon from the first location to a second location in proximity to a second side of the touch screen;
translating a plurality of action icons onto the touch screen; and
monitoring the touch screen for additional touches in proximity to at least one of the composite icon and the plurality of action icons,
wherein detecting the touch in proximity to the composite icon causes the action icons to be displayed if the action icons are not displayed before the touch is detected, and
wherein detecting the touch in proximity to the composite icon causes the action icons to be hidden if the action icons are displayed before the touch is detected.

2. The computerized method of claim 1, wherein the composite icon further includes an object icon and a signpost icon.

3. The computerized method of claim 2, wherein the signpost icon further includes a first state when the action icons are displayed and a second state when the action icons are not displayed.

4. The computerized method of claim 1, wherein the plurality of action icons further includes a command icon for causing a plurality of additional action icons to be displayed.

5. The computerized method of claim 4, further comprising:
detecting a second touch on the touch screen in proximity to the command icon;
translating one or more of the plurality of action icons off of the touch screen; and
translating the plurality of additional icons onto the touch screen from the first side of the touch screen.

6. The computerized method of claim 1, wherein the first side is a left edge of the touch screen and the second side is a right edge of the touch screen.

7. The computerized method of claim 2, wherein the signpost icon is graphically labeled to indicate respective functionality, and is smaller than the object icon.

8. A computing device, comprising:
a touch screen;
one or more processors;
a non-transitory memory storing computer-readable instructions that, when executed by the one or more processors, cause the one or more processors to:
display, at a first location in proximity to a first side of the touch screen, a composite icon representing a data object and functionality associated with the data object;
detect a touch on the touch screen in proximity to the composite icon;
translate the composite icon from the first location to a second location in proximity to a second side of the touch screen;
translate a plurality of action icons onto the touch screen; and
monitor the touch screen for additional touches in proximity to at least one of the composite icon and the plurality of action icons,
wherein detecting the touch in proximity to the composite icon causes the action icons to be displayed if the action icons are not displayed before the touch is detected, and
wherein detecting the touch in proximity to the composite icon causes the action icons to be hidden if the action icons are displayed before the touch is detected.

9. The computing device of claim 8, the composite icon further including an object icon and a signpost icon.

10. The computing device of claim 9, the signpost icon further including a first state when the action icons are displayed and a second state when the action icons are not displayed.

11. The computing device of claim 8, the plurality of action icons further including a command icon for causing a plurality of additional action icons to be displayed.

12. The computing device of claim 11, the computer-readable instructions further causing the one or more processors to:
detect a second touch on the touch screen in proximity to the command icon;
translate one or more of the plurality of action icons off the touch screen; and
translate the plurality of additional icons onto the touch screen from the first side of the touch screen.

13. The computing device of claim 8, wherein the first side is a left edge of the touch screen and the second side is a right edge of the touch screen.

14. The computing device of claim 9, wherein the signpost icon is graphically labeled to indicate respective functionality, and is smaller than the object icon.

15. A non-transitory computer-readable medium having executable instructions operable to, when executed by a computing device, cause the computing device to:
display, at a first location in proximity to a first side of the touch screen, a composite icon representing a data object and functionality associated with the data object;
detect a touch on the touch screen in proximity to the composite icon;
translate the composite icon from the first location to a second location in proximity to a second side of the touch screen;
translate a plurality of action icons onto the touch screen; and
monitor the touch screen for additional touches in proximity to at least one of the composite icon and the plurality of action icons,
wherein detecting the touch in proximity to the composite icon causes the action icons to be displayed if the action icons are not displayed before the touch is detected, and
wherein detecting the touch in proximity to the composite icon causes the action icons to be hidden if the action icons are displayed before the touch is detected.

16. The non-transitory computer-readable medium of claim 15, the composite icon further including an object icon and a signpost icon.

17. The non-transitory computer-readable medium of claim 15, the signpost icon further including a first state while the action icons are displayed and a second state while the action icons are not displayed.

18. The non-transitory computer-readable medium of claim 15, the plurality of action icons further including a command icon for causing a plurality of additional action icons to be displayed.

19. The non-transitory computer-readable medium of claim 18, the executable instructions further operable to cause the computing device to:
detect a second touch on the touch screen in proximity to the command icon;
hide one or more of the plurality of action icons; and
display the plurality of additional action icons.

20. The non-transitory computer-readable medium of claim 16, wherein the first state of the signpost icon and the second state of the signpost icon are graphically labeled to indicate respective functions and are each smaller than the object icon, and wherein the first side is a left edge of the touch screen and the second side is a right edge of the touch screen.
